(19) United States
(12) Patent Application Publication
(10) Pub. No.: US 2005/0086797 A1
(43) Pub. Date: Apr. 28, 2005

(54) Aluminum heat sink for a solid state relay having ultrasonically welded copper foil

(76) Inventor: Eugen Popescu, Santee, CA (US)

Correspondence Address: Gibson, Dunn & Crutcher LLP;Attn: Stanley J. Gradisar, Suite 4100, 1801 California Street, Denver, CO, 80202, US

(21) Appl. No.: 10/692,960

(22) Filed: Oct. 24, 2003

(51) Int. Cl. H01H 11/00

(52) U.S. Cl. 29/622; 29/592

(57) ABSTRACT

Instead of soldering a circuit board or substrate to a nickel-plated aluminum heat sink for solid state relay applications, the present invention utilizes ultrasonic welding to weld a copper foil to a non-nickel-plated aluminum heat sink. The circuit board or substrate is subsequently soldered to the copper foil. The superior solderability of copper foil brings increased solder coverage between the heat sink and substrate, improving the heat transfer from the output switching element to the heat sink. This method eliminates the need for fixturing since the copper foil is surrounded by non-nickel-plated aluminum that is non-solderable by commonly used solders. This method also eliminates the high costs associated with nickel-plating and hazardous waste disposal, since no chemical wastes are produced. With this method, the same size solid state relay is now able to carry more current due to the better heat transfer and heat dissipation capabilities.

### FIELD OF THE INVENTION

This invention relates to solid state relays, and more particularly, to an aluminum heat sink for a solid state relay having ultrasonically welded copper foil on the surface that receives the circuit board or substrate of the solid state relay.

### BACKGROUND OF THE INVENTION

In power electronics, one of the biggest challenges encountered is the dissipation of the heat generated by semiconductors. Commonly, aluminum heat sinks are attached to the circuit board or substrate with thermally conductive adhesives or solder alloys. While the first option of using conductive adhesives gives satisfactory results for lower power applications, the lower thermal conductivity of these adhesives limits their usage in high power applications, in which case solder alloys are generally used.

However, the use of solder alloys raises other important issues. The solder alloys commonly used in the electronics industry do not “wet” aluminum. In general, a layer of nickel must be plated onto the surface of the aluminum heat sink in order to achieve the solderability necessary. Though this approach has proved reliable over the years, it is well known that nickel, compared to other metals, has a lower solderability quality, which lowers the solder coverage, and ultimately affects the life span and performance of the electronic product. Moreover, the strict environmental regulations imposed on nickel-plating operations have increased the price of plating due to the higher costs associated with treating and disposing of the chemical waste byproducts. The present invention solves these and other needs in the art.

### BRIEF DESCRIPTION OF THE DRAWINGS

FIG. 1 shows a cross section view taken along line B-B′ in FIG. 2 of a solid state relay in partial assembly, showing the aluminum heat sink and copper foil, substrate, lead frame, and SCR component layers in an embodiment of the present invention.

FIG. 2 shows a view taken along line A-A′ in FIG. 1 showing the copper foil on the surface of the aluminum heat sink.

### DETAILED DESCRIPTION OF THE INVENTION

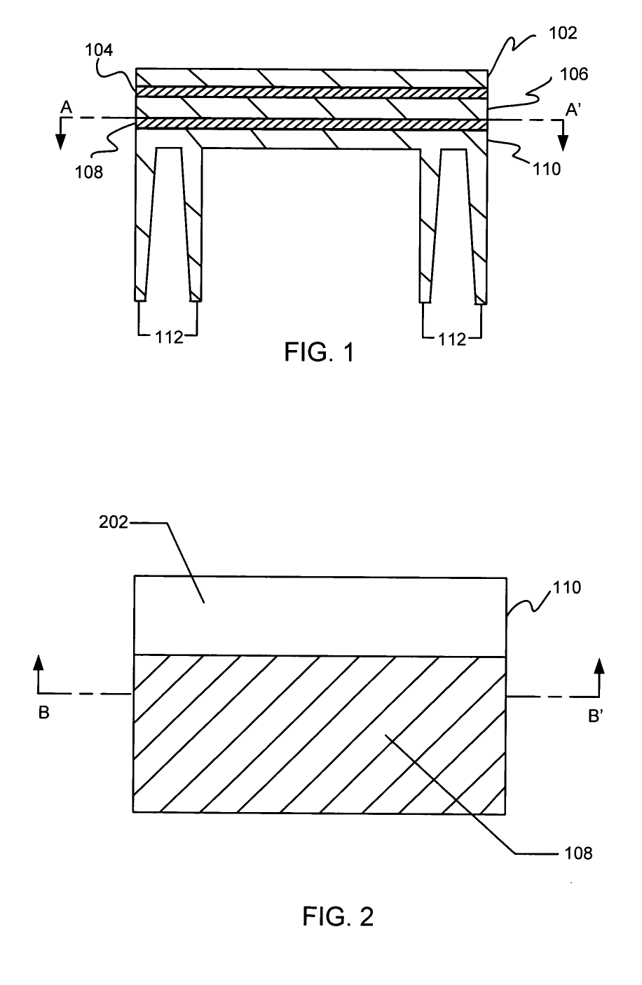

Referring now to the Figures, in which like reference numerals refer to structurally and/or functionally similar elements thereof, FIG. 1 shows a cross section view taken along line B-B′ in FIG. 2 of a solid state relay in partial assembly, showing the aluminum heat sink and copper foil, substrate, lead frame, and SCR component layers in an embodiment of the present invention. Referring now to FIG. 1, it is a daunting problem to keep the junction temperatures in solid state relays (SSRs) within operating limits. SSRs with very high current capabilities may need to dissipate heat in excess of 200 watts. Multi-pole relays pose greater problems because power dissipation in the form of heat is multiplied by the number of poles.

Typical SSRs incorporate a silicon-controlled rectifier (SCR), triac, or field-effect transistor (FET) as the Output Switching Element Layer 102. One skilled in the art will recognize that the component layers shown in FIG. 1 may not extend the entire width as shown. For high power SSRs, these components typically are in die form and placed on a Lead Frame Layer 104, which is laid down on a Substrate Layer 106. The lead frames of Lead Frame Layer 104 are typically made of copper or nickel-plated copper. For low power SSRs, Output Switching Element Layer 102 may be soldered directly to Substrate Layer 106, eliminating Lead Frame Layer 104. Each layer and connection introduces a thermal barrier of specific thermal resistance. When the relay is on, current flowing through the output device creates a voltage drop across it. Power dissipates in the form of heat.

Heat can be transferred by conduction, convection, and to a lesser degree, radiation. In conduction, heat transfer takes place through a solid medium. In convection, heat is transferred by gas or fluid due to temperature differences. An SSR tends to retain heat because of the limited size of its substrate and because the substrate is the mounting surface. Therefore, a heat sink is often used to facilitate cooling. Heat is transferred by conduction from the SCR, triac, or FET to the lead frame to the substrate to the heat sink. The heat sink then removes and dissipates heat mainly through convection, thereby helping to maintain the SSRs temperature within an operating range. Heat sinks are generally made from an aluminum alloy extrusion, often with fins that increase surface area for airflow.

As stated above, thermally conductive adhesives between the substrate and heat sink for lower power applications, and solder alloys used in conjunction with a nickel-plated heat sink for higher power applications, have been utilized for more many years. The present invention takes a new approach which has produced very favorable results. Instead of either of the two solutions described above, the present invention utilizes a Copper Foil 108 which is ultrasonically welded to non-nickel-plated aluminum Heat Sink 110 having Fins 112. Substrate Layer 106 is subsequently soldered to Copper Foil 108. Copper Foil 108 is typically about 0.003 inches thick. One skilled in the art will recognize that many different types of heat sinks are available, and that Heat Sink 110 with Fins 112 shown is illustrative only, and is not limited to the type of heat sink with fins shown. The thermal transfer between the SSR and Heat Sink 110 depends upon the effectiveness of the interface between the two.

FIG. 2 shows a view taken along line A-A′ in FIG. 1 showing the copper foil on the surface of the aluminum heat sink. Referring now to FIG. 2, an area of Flat Surface 202 of Heat Sink 110 has Copper Foil 108 which has been ultrasonically welded to Flat Surface 202. One skilled in the art will recognize that more or less area of Flat Surface 202 than shown in FIG. 2 may have Copper Foil 108 welded thereto. FIG. 2 is meant to be illustrative only, and the invention is not limited to the configuration shown. Also, Copper Foil 108 may have a certain pattern to it depending upon the particular application. The invention is not limited to that shown in FIG. 2.

Ultrasonic welding bonds material together from energy derived in the form of mechanical vibrations. The welding tool, called a sonotrode, couples to the part to be weld. The part to be welded on remains static. The two parts to be bonded are simultaneously pressed together. The simultaneous action of static and dynamic forces causes a fusion of the parts without having to use additional material. The parts to be welded are not heated to melting point, but are connected by applying pressure and high-frequency mechanical vibrations. The mechanical vibrations used during ultrasonic metal welding are introduced horizontally.

During ultrasonic metal welding, a complex process is triggered involving static forces, oscillating shearing forces, and a moderate temperature increase in the welding area. Heat Sink 110 and Copper Foil 108 are placed in a fixed machine part, called an anvil, and the sonotrode oscillates horizontally during the welding process at high frequency (usually 20, 35, or 40 kHz). These frequencies are above that audible to the human ear. Ultrasonic metal welding is not characterized by superficial adhesion or glued bonds. It is proven that the bonds are solid, homogeneous and lasting joints. The two materials bonded together penetrate each other through a diffusion process.

The ultrasonic welding takes place typically between about 0.1 to 1.0 seconds, depending upon the materials being welded, and at power levels of between about 2,000 to 4,000 watts. Due to the size of Copper Foil 108 to be welded to Heat Sink 110, currently available ultrasonic welding equipment must perform the weld in a series of essentially non-overlapping parallel passes along a length of Copper Foil 108, only welding a portion of Copper Foil 108 at a time. After a first pass, the sonotrode is shifted perpendicular to the direction of movement along the length of Copper Foil 108 a distance equal to the width of the just completed weld. A second pass along the length of Copper Foil 108 is made, welding another portion of Copper Foil 108, and the sonotrode is again shifted perpendicular to the direction of movement a distance equal to the width of the just completed weld from the second pass. Additional passes are made until the entire width of Copper Foil 108 has been welded along its length to Heat Sink 110. One skilled in the art will recognize that as improvements are made in ultrasonic welding equipment, and the area weldable by the sonotrode increases, it may be possible to affect the weld of Copper Foil 108 to Heat Sink 110 in only one pass or one application of power.

Utilizing the present invention over the prior art approach to the problem has many advantages. First, the superior solderability of Copper Foil 108 brings increased solder coverage between Heat Sink 110 and Substrate Layer 106, improving the heat transfer from Output Switching Element Layer 102 to Heat Sink 110. Since the ultrasonically welded Copper Foil 108 has a certain pattern imprinted thereon, an increased area is available for contact with the solder. This also translates in better heat dissipation and increased reliability of the SSR.

Second, this method eliminates the need for fixturing. A fixture is a device that holds loose parts in a fixed position prior to assembly. Since the solderable area of Copper Foil 108 is surrounded by material that is non-solderable by commonly used solders (the aluminum of Flat Surface 202), during re-flow, the solder alloy will not spread over, and due to its surface tension, will “center” Substrate Layer 106 on the surface area of Copper Foil 108. Except in special cases where very accurate alignment is required, or other particular reasons, the use of fixtures is no longer necessary with the present invention.

Third, this method eliminates the need for nickel-plating the aluminum for Heat Sink 110, and the environmental restrictions mentioned above are not applicable since this approach does not produce any chemical waste. In addition, the application of this method is not labor intensive and the material and power consumptions are minimal, resulting in significant cost reductions on the order of one-tenth the costs of the two common methods currently practiced in the art. With this method, the same size SSR is now able to carry more current due to better heat transfer and heat dissipation capabilities.

A standard stress test was performed to verify the efficacy of the present invention. The test was designed to evaluate the reliability of the bond between Copper Foil 108 and a non-nickel-plated aluminum base plate of the present invention compared to current standards of performance. Eight initial units were constructed with 0.003 inch thick Copper Foil 108 ultrasonically welded to a non-nickel-plated aluminum base plate (without fins). The ultrasonic weld equipment utilized required six passes, as described above, to complete the weld for each unit. Regarding the Heat Sink Sub-Assemblies (HSSA), the ceramic substrates were soldered to the ultrasonically welded Copper Foil 108 with 60Sn/40Pb solder only. Other solders that could be used include 63Sn/37Pb and 62Sn/36Pb/2Ag, but 60Sn/40Pb is preferred. The eight units under test (UUT) were designated as UUT #1, UUT #2, UUT #3, UUT #4, UUT #5, UUT #6, UUT #7, and UUT #8. All eight units are 40 Ampere type sub-assemblies with copper lead frames and RTV silicone potting. Temperatures were monitored with thermocouples on the cathode jumpers and in the center of the base plates.

All eight units had all outputs connected in series, with no external heat sink attached. An electric current was used to heat up the units to 125° C. and then cooled by forced air with fans down to 40° C. All units were temperature cycled for one to two hours to allow them to stabilize between the high temperature of 125° C. and the low temperature of 40° C. After this stabilization period, the setup was changed from a temperature cycle to a time cycle. One complete time cycle consists of a hot period of time in which the current is turned on, which heats up the units, plus a cold period of time in which the current is turned off and forced air cooling is turned on, where the units cool down. The time cycle was conducted under the following parameters:

| | |
|---|---|
| Hot Period: | 99 seconds |
| Cold Period: | 141 seconds |
| Load Type: | Resistive |
| Load Current: | 28.0 Amperes |
| Failure: | Defined as occurring when the temperature |
| | reaches 150° C. during any cycle. |

Table One below shows the results of the test under the above parameters.

TABLE ONE

| | | Solder Composition | | Total Cycles |
|---|---|---|---|---|
| UUT | Lead Frame | HSSA | Ceramic | Before |
| Number | Type | Construction | Base Plate | Failure |
| UUT #1 | Copper | 60Sn/40Pb | Copper Foil | 11,092 |
| UUT #2 | Copper | 60Sn/40Pb | Copper Foil | 10,915 |
| UUT #3 | Copper | 60Sn/40Pb | Copper Foil | — |
| UUT #4 | Copper | 60Sn/40Pb | Copper Foil | — |
| UUT #5 | Copper | 60Sn/40Pb | Copper Foil | — |
| UUT #6 | Copper | 60Sn/40Pb | Copper Foil | — |
| UUT #7 | Copper | 60Sn/40Pb | Copper Foil | — |
| UUT #8 | Copper | 60Sn/40Pb | Copper Foil | — |

The following observations were noted:

At 10,915 cycles, UUT #2 failed. A visual inspection of the unit revealed that the overheating was not caused by a failure of the copper/aluminum ultrasonic welding component. The unit failed because of a crack in a solder joint above the ceramic substrate.

At 11,092 cycles, UUT #1 was removed from the fixture to perform further testing. A visual inspection under magnification of the copper/aluminum ultrasonic weld was performed. There were no visible signs of degradation of the weld. Next, the aluminum base plate with the copper foil welded thereto was put in a vise and bent to nearly a 90° angle. Another visual inspection was performed and again, no signs of degradation of the weld were observed.

At 11,776 cycles, the test was stopped due to satisfactory performance, with none of the remaining units having failed. Any result over 10,000 cycles is considered more than acceptable for this power semiconductor application. The remaining units were also bent and visually inspected. No signs of degradation of the weld were observed.

Having described the present invention, it will be understood by those skilled in the art that many changes in construction and circuitry and widely differing embodiments and applications of the invention will suggest themselves without departing from the scope of the present invention.

1. A method for making a solid state relay, the method comprising the steps of:
(a) welding ultrasonically a copper foil to a heat sink;
(b) soldering a substrate to said copper foil; and
(c) soldering an output switching element to said substrate;
wherein said copper foil increases solder coverage between said heat sink and said substrate, improving a heat transfer from said output switching element to said heat sink.

2. A method according to claim 1 wherein step (c) is replaced with a new step (c) and further comprises step (d):
(c) soldering at least one lead frame to said substrate; and
(d) soldering said output switching element to said at least one lead frame.

3. A method according to claim 1 wherein step (a) further comprises the step of:
welding ultrasonically said copper foil to a non-nickel-plated aluminum heat sink.

4. A method according to claim 1 wherein step (a) further comprises:
welding ultrasonically a portion of said copper foil to said heat sink in a first pass at between about 0.1 to 1.0 seconds at a power level of between about 2,000 to 4,000 watts.

5. A method according to claim 4 wherein step (a) further comprises:
welding ultrasonically additional portions of said copper foil to said heat sink in a plurality of additional passes that are essentially non-overlapping and parallel until all of said copper foil is welded to said heat sink.

6. A method according to claim 1 wherein step (a) further comprises:
welding ultrasonically said copper foil to said heat sink, wherein said copper foil is about 0.003 inches thick.

7. A method according to claim 1 wherein said at least one lead frame is made from at least a one of copper and nickel-plated copper.

8. A method according to claim 1 wherein step (b) further comprises soldering said substrate to said copper foil with at least a one of a solder composition of 60Sn/40Pb, 63Sn/37Pb, and 62Sn/36Pb/2Ag.

9. A solid state relay comprising:
a heat sink;
a copper foil ultrasonically welded to said heat sink;
a substrate soldered to said copper foil; and
an output switching element soldered to said substrate;
wherein said copper foil increases solder coverage between said heat sink and said substrate, improving a heat transfer from said output switching element to said heat sink.

10. The solid state relay according to claim 9 wherein at least one lead frame is soldered to said substrate instead of said output switching element, and said output switching element is soldered to said at least one lead frame.

11. The solid state relay according to claim 9 wherein said heat sink is made of a non-nickel-plated aluminum.

12. The solid state relay according to claim 9 wherein a portion of said copper foil is ultrasonically welded to said heat sink in a first pass at between about 0.1 to 1.0 seconds at a power level of between about 2,000 to 4,000 watts.

13. The solid state relay according to claim 12 wherein additional portions of said copper foil are ultrasonically welded to said heat sink in a plurality of additional passes that are essentially non-overlapping and parallel until all of said copper foil is welded to said heat sink.

14. The solid state relay according to claim 9 wherein said copper foil is about 0.003 inches thick.

15. The solid state relay according to claim 9 wherein said at least one lead frame is made from at least a one of copper and nickel-plated copper.

16. The solid state relay according to claim 9 wherein said substrate is soldered to said copper foil with at least a one of a solder composition of 60Sn/40Pb, 63Sn/37Pb, and 62Sn/36Pb/2Ag.
